(19) United States
(12) Patent Application Publication
(10) Pub. No.: US 2024/0093543 A1
(43) Pub. Date: Mar. 21, 2024

(54) DOOR CLOSING DEVICE

(71) Applicant: Koblenz S.p.A., Coriano RN (IT)

(72) Inventor: Lorenzo FERRONI, Coriano RN (IT)

(73) Assignee: Koblenz S.p.A., Coriano RN (IT)

(21) Appl. No.: 17/767,928

(22) PCT Filed: Dec. 9, 2020
(86) PCT No.: PCT/IT2020/050304

§ 371 Date: Apr. 11, 2022

(30) Foreign Application Priority Data
Dec. 18, 2019 (IT) 102019000024496

(51) Int. Cl. E05F 3/20; E05F 1/12

(52) U.S. Cl. CPC E05F 3/20; E05F 1/1284; E05Y 2201/21; E05Y 2201/716; E05Y 2201/722; E05Y 2900/132

(57) ABSTRACT

The present invention relates to a device (4) for closing a door (1) which is rotatably constrained to a relative anchoring structure (2) and movable between a closing position and a maximum opening position, said anchoring structure (2) being either a fixed structure or a further door. Said device (4) comprises: a first fixing element (5) fixable, in use, to the door (1) or to the anchoring structure (2) of the door (1); a second fixing element (6) fixable, in use, to the anchoring structure (2) of the door (1) or to the door (1); at least one elastic flexible element (11) which performs, due to its configuration, an elastic function when it is subjected to bending; fixing means (12) by which said at least one elastic flexible element (11) is fixed to said second fixing element (6); and engaging means (14) by which said at least one elastic flexible element (11) remains engaged to said first fixing element (5) during the relative motion between said first (5) and said second fixing element (6), which is caused by said door (1) moving between said closing position and said maximum opening position and between said maximum opening position and said closing position. In the configuration assumed by the device (4) when the door (1) is at least partially open, said at least one elastic flexible element (11) is subjected to bending and tending to automatically move said door (1) to said closing position.

### TECHNICAL FIELD

The present invention relates to an improved device for closing a door. More specifically, the invention relates to a device for closing a door which is rotatably constrained to a relative anchoring structure and movable between a closing position and a maximum opening position.

Said anchoring structure could be a fixed structure, such as the side of a piece of furniture or a jamb, or another door, for example a door with traditional or folding-like opening.

In the following, the description will relate to a closing device for a hinged door, or for a leaf rotatably connected to a jamb, but it is very clear that it should not be considered limited to this specific use, as this device can be used as mentioned above also for rotatably connecting said door to a fixed structure other than a jamb, such as for example the side of a piece of furniture, or a further movable door.

### BACKGROUND ART

Currently there are various return systems for hinged doors, which however have various disadvantages and technical drawbacks, mainly due to the fact that they are visible from the outside during all the operating phases, and/or due to the fact that they can cause problems because of the excessive (or not proper) efforts exerted on the related hinges, and/or due to the need to drill holes in the floor or walls, and/or due the limited range of door opening, and/or due to high costs.

### DISCLOSURE OF THE INVENTION

In light of the above, therefore, the purpose of the present invention is to provide a device for closing a door, which is completely hidden when said door is in the closed position.

Another purpose of the invention is to provide a device for closing a door which, during use, does not subject the related components to an excessive stress.

A further purpose of the present invention is to provide a device for closing a door, which is not structurally complex.

A further purpose of the invention is to provide a device for closing a door provided with an adjustable door braking capacity.

A specific object of the invention is therefore a device for closing a door which is rotatably constrained to a relative anchoring structure and movable between a closing position and a maximum opening position, said anchoring structure being either a fixed structure or a further door; said device comprising: a first fixing element fixable, in use, to the door or to the anchoring structure of the door; a second fixing element fixable, in use, to the anchoring structure of the door or to the door; at least one elastic flexible element which performs, due to its configuration, an elastic function when it is subjected to bending; fixing means by which said at least one elastic flexible element is fixed to said second fixing element; and engaging means by which said at least one elastic flexible element remains engaged to said first fixing element during the relative motion between said first and said second fixing element, which is caused by said door moving between said closing position and said maximum opening position and between said maximum opening position and said closing position. In the configuration assumed by the device when the door is at least partially open, said at least one elastic flexible element is subjected to bending and tending to automatically move said door to said closing position.

According to the invention, preferably said device comprises a plurality of elastic flexible elements, each performing, due to its configuration, an elastic function when it is subjected to bending, said elastic flexible elements being adjacent to one another, fixed to said second fixing element by the fixing means, and kept engaged in said first fixing element by the engaging means during the relative motion between said first and said second fixing element, which is caused by said door moving between said closing position and said maximum opening position and between said maximum opening position and said closing position, in the configuration assumed by the device when the door is at least partially open said plurality of elastic flexible elements being subjected to bending and tending to automatically move said door to said closing position.

According to the invention, conveniently, an opening is formed in at least one first elastic flexible element of said plurality of elastic flexible elements, and at least one second elastic flexible element of said plurality of elastic flexible elements comprises a connecting element which is slidingly engaged in said opening.

According to the invention, preferably each elastic flexible element is a foil.

According to the invention, advantageously in the configuration assumed by the device when said door is in said closing position, said at least one elastic flexible element is completely placed within said first and said second fixing element in combination.

Further according to the invention, in the configuration assumed by the device when said door is in said maximum opening position, a first end portion of said at least one elastic flexible element is placed within said second fixing element, a second end portion of said at least one elastic flexible element, which is opposite said first end portion, is placed within said first fixing element, and an intermediate portion of said at least one elastic flexible element is placed between said first fixing element and said second fixing element, outside the latter ones.

According to the invention, conveniently, said device may comprise a damping system for damping the return movement of said first fixing element towards said second fixing element, or vice versa, when said door moves from said maximum opening position to said closing position.

According to the invention, preferably said damping system comprises a rack and a gear which is configured to engage with said rack, said damping system being connected with said at least one elastic flexible element and said first fixing element.

A further object of the invention is a door system for a door or a piece of furniture, comprising an anchoring structure and a door which is rotatably constrained to the anchoring structure and movable between a closing position and a maximum opening position, said anchoring structure being either a fixed structure or a further door, the system further comprising a device for closing the door as above indicated, the first fixing element being fixed to the door or the anchoring structure of the door, preferably to the door, the second fixing element being fixed to the anchoring structure or the door, preferably to the anchoring structure.

According to the invention, preferably the first fixing element is fitted within a thickness of the door or the anchoring structure, preferably of the door; the second fixing element is fitted within a thickness of the anchoring structure or the door, preferably of the anchoring structure; the device for closing the door being concealed and invisible when the door is in closing position.

### BRIEF DESCRIPTION OF THE DRAWINGS

The present invention will now be described for illustrative but not limitative purposes, according to its preferred embodiments, with particular reference to the figures of the attached drawings, in which:

FIG. 1 is an axonometric view of a hinged door pivotally constrained to a jamb and equipped with a device for closing a door according to the present invention;

FIG. 2 is a detail view of FIG. 1;

FIG. 3 is a cross-sectional view of a hinged door, in the closed position, provided with a device for closing a door according to the present invention;

FIG. 4 is a cross-sectional view of the hinged door shown in FIG. 3, in the fully open position;

FIG. 5 is a cross-sectional view of the hinged door shown in FIGS. 3 and 4, in the half-open position;

FIG. 6 is a first axonometric view of a device for closing a door according to the present invention, in the configuration of complete opening;

FIG. 7 is a second axonometric view of the device for closing a door shown in FIG. 6, in the configuration of complete opening; and

FIG. 8 is a rear view of the device for closing a door shown in FIGS. 6 and 7, in the configuration of complete opening.

### EMBODIMENTS OF THE INVENTION

In the various figures similar parts will be indicated with the same numerical references.

With reference to the attached drawings, reference numeral 1 indicates a hinged door rotatably constrained to a jamb 2 and movable in rotation between a closed position and a fully open position.

In particular, the door 1 is connected to the jamb 2 by means of hinges 3a, 3b and has a closing device 4, arranged between these hinges 3a, 3b, to facilitate the closure of the door 1 from an opening position to the related closing position. The figures show the solution with two hinges 3a, 3b, but it is clear that the invention also applies to the case in which the door 1 is connected to the jamb 2 with a greater number of hinges.

As mentioned in the preamble of the description, the jamb 2 could also be a side of a piece of furniture or a different fixed anchoring structure.

Alternatively, instead of being connected to the jamb 2, the door 1 could be connected to a second door pivotally linked to a jamb or to another fixed structure.

Therefore, the anchoring structure of the door 1 could be a fixed structure, such as for example the jamb 2 or a side of a piece of furniture, or a mobile structure, such as a door.

In particular, when the aforementioned anchoring structure is a fixed structure, the closing position of the door is meant to be the configuration according to which the door is coplanar to this fixed structure; whereas the expression “fully open position” of the door indicates the position assumed by the latter when it is rotated, normally 90° or 180°, until the maximum permitted stroke is reached.

When, on the other hand, the aforementioned anchoring structure is a further door rotatably constrained to a fixed structure, the closed position is meant to be the condition that occurs when the two doors are in a coplanar position; whereas the fully open position of the door which is not directly connected to the fixed structure occurs when said door is at least substantially perpendicular to the plane of the further door, or even more rotated with respect to (at the limit superimposed on) the other door, according to the expected angle of maximum rotation of said door with respect to the further door.

On the other hand, in the case in which the aforementioned anchoring structure is a further door which is rotatably linked to a fixed structure, and the two doors are rotatably connected to each other in a folding-door-like configuration, the closing position occurs when the two doors are coplanar; while the fully open position is obtained when the two leaves are side by side, i.e. substantially superimposed.

The device 4 for closing a door comprises a first fixing element 5 fixable to the door 1 or to the jamb 2 and a second fixing element 6 fixable to the jamb 2 or to the door 1.

Clearly, if the first fixing element is fixed to the door, the second fixing element is fixed to the jamb.

Conversely, where the first fixing element is fixed to the jamb, the second fixing element is fixed to the door.

In the configuration shown in the attached figures, the first fixing element 5 is fixed to the door 1, while the second fixing element 6 is fixed to the jamb 2.

In particular, the first fixing element 5 and the second fixing element 6 are configured as two recessed elements intended to be housed in corresponding cavities made in the door 1 and in the jamb 2.

The first fixing element 5 and the second fixing element 6 are provided with respective flanges 7, 8 to allow the relative fixing, by means of screws 9, 10, to the door 1 and to the jamb 2.

The device 4 for closing the door further comprises at least one elastic flexible element 11 which performs, due to its configuration, an elastic function when it is subjected to bending.

Preferably, this closure device 4 comprises a pack or a plurality of elastic flexible elements 11 adjacent to each other and mutually connected in a sliding manner.

Preferably, each elastic flexible element 11 is constituted by a sheet, even more preferably a sheet made of harmonic steel.

In particular, the reciprocal sliding of the sheet 11 is obtained by making an opening in each sheet 11, with the exception of an external sheet 11 ‘of the pack of foils, and fixing a connecting element to said external sheet 11’, such as for example a pin, slidingly engaged in each opening in such a way as to allow slippage between adjacent sheets.

The presence of a plurality of elastic flexible elements 11 adjacent to each other and mutually connected in a sliding manner makes it possible that when the door 1 is arranged in the maximum opening position, each elastic sliding element 11 bends according to a radius of limited curvature; this allows, therefore, a reduction of the mechanical stress these elastic flexible elements 11 are subjected to every time the door 1 is opened.

In particular, in the case of the sheets 11, the presence of several sheets 11 side by side and slidingly engaged with each other makes it possible that when the door 1 is placed in the maximum opening position, each sheet 11 bends according to a limited radius of curvature; this allows, therefore, to reduce the mechanical stress to which these sheets 11 are subjected every time the door 1 is opened.

The second fixing element 6 comprises fixing means 12 to fix one end of said external sheet 11′ to said second fixing element 6.

In the specific example shown in the attached figures, these fixing means 12 consist of a clamp.

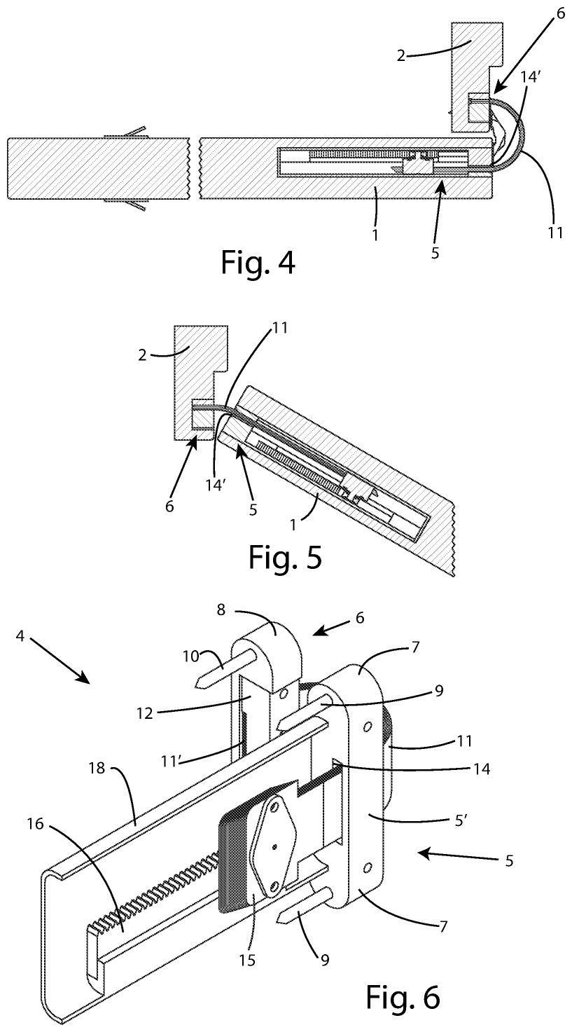

The device 4 for closing the door is also provided with engaging means 14 by which said at least one elastic flexible element 11 remains engaged to said first fixing element 5 during the relative motion between said first 5 and said second fixing element 6, which is caused by said door 1 moving between said closing position (see FIG. 3) and said maximum opening position (see FIG. 4), and vice versa.

In particular, the first fixing element 5 comprises an anchoring body 5′, in which the aforementioned flanges 7 are made.

This anchoring body 5′ is composed of two pieces 13a, 13b rigidly coupled to each other in such a way as to form, in their coupling configuration, a slot 14 which performs the function of the aforementioned engaging means, allowing the pack of sheets 11 passing through it to remain engaged, in a sliding manner, to the anchoring body 5′.

In the anchoring body 5′, in correspondence with a lateral edge of the slit 14, an oblique surface 14′ is formed, which faces the pack of sheets 11 to facilitate the sliding of the latter through this slit 14 during the opening and closing movements of the door 1.

In the configuration assumed by the device 4 when the door 1 is at least partially open, said at least one elastic flexible element 11 is subjected to bending and tends to automatically move said door 1 to said closing position thanks to the return action exerted by said at least one elastic flexible element 11 on the first fixing element 5.

In correspondence with the end of said at least one elastic flexible element 11 opposite the relative end fixed to the second fixing element 6 there is also an abutment element 15, preferably having a “T” shape, which performs the function of preventing, during the opening of the door 1, the extraction of said at least one elastic flexible element 11 from the slot 14, thanks to the abutment between the abutment element 15 and the parts of the first fixing element 5 adjacent to this slot 14. In the solution featuring a flexible sheet 11 (or a plurality of flexible sheets 11), this abutment element can be obtained directly from portions of the same sheet 11 (or of each of the sheets 11 of the plurality of sheets 11), by giving the sheet 11 (or each sheet 11) a “T” signature in the plane of the sheet 11 itself (as also illustrated in FIG. 6).

The device 4 for closing the door further comprises a damping system for damping the return movement of said first fixing element 5 towards said second fixing element 6, or vice versa, when the door 1 moves from the maximum opening position shown in FIG. 4 to the closing position illustrated in FIG. 3.

Preferably, the aforementioned damping system is connected to said at least one elastic flexible element 11 and to the first fixing element 5, and comprises a rack 16 and a gear 17 which is configured so as to be able to engage with the rack 16.

In particular, the rack 16 is anchored to the internal part of a first half-shell 18a which is fixed to the rear part of the anchoring body 5′ and forming part of the first fixing element 5.

The gear 17, on the other hand, meshes with the rack 16 and is axially connected to a rotary braking device 19 anchored, in turn, to the abutment element 15 and to the at least one elastic flexible element 11, so that when the door 1 automatically moves from an open position to the closed position due to the elastic return action exerted by said at least one elastic flexible element 11, said rotary braking device 19 brakes the closing movement of the door 1.

The gear 17 is connected to a damper, for example of the fluid type (which, in particular, can only be active in one of the two directions of rotation of the gear 17).

The first fixing element 5 also comprises a second half-shell 18b rigidly coupled, in a removable manner, to the aforementioned first half-shell 18a so that both the abutment element 15 and the aforementioned damping system are contained within the housing formed by the first 18a and the second half-shell 18b.

As can be seen from FIG. 3, in the configuration assumed by the closing device 4 when the door 1 is in the closed position, said at least one elastic flexible element 11 is arranged completely inside the first 5 and the second fixing element 6 in combination, thus leaving no part of the closing device 4 visible from the outside.

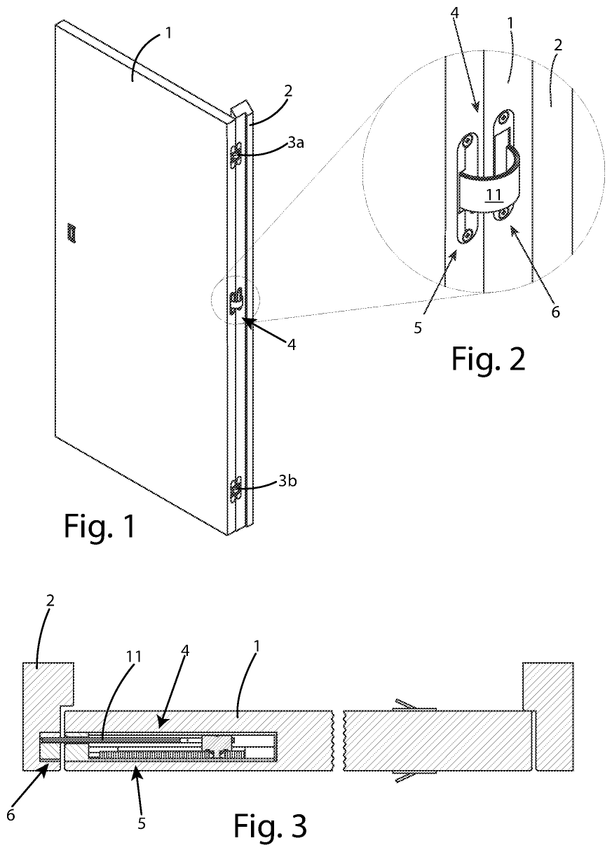

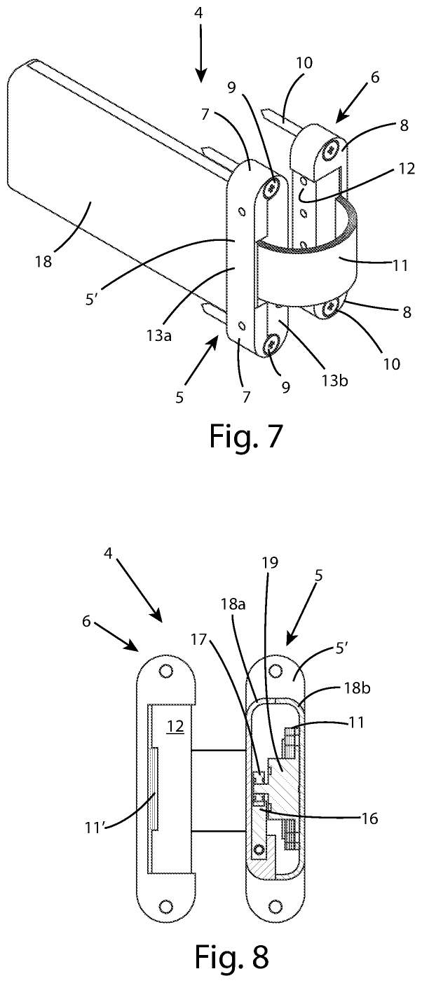

On the other hand, when the door 1 is in the maximum opening position shown in FIGS. 4, 6 and 7, a first end portion of said at least one elastic flexible element 11 is arranged inside the second fixing element 6, a second end portion of said at least one elastic flexible element 11, opposite to said first end portion, is arranged inside the first fixing element 5, and an intermediate portion of said at least one elastic flexible element 11 is arranged between the first fixing element 5 and the second fixing element 6, on the outside of these, as shown in FIGS. 1, 2, 4, 6 and 7.

The above-described closing device according to the present invention therefore allows the automatic closing of the door to be effectively achieved from a related opening position, while remaining invisible from the outside when the door is in the closed position and visible only in minimum part when this door is open.

The same closing device also has a considerable resistance to fatigue thanks to its particular structure, which is such as to prevent the related elastic members from being excessively stressed during the movements of the door.

Furthermore, the assembly of the device and its operation are substantially independent of the positioning, type and number of hinges used for the door. This allows an application of the same device on various types of doors or leaves (even without excessive changes).

The present invention has been described according to its preferred embodiments for illustrative but not limitative purposes, but it is understood that variations and/or modifications may be made by those skilled in the art without thereby departing from the scope of protection as defined by the attached claims.

1. Device for closing a door which is rotatably constrained to a relative anchoring structure and movable between a closing position and a maximum opening position, said anchoring structure being either a fixed structure or a further door, the device comprising:
a first fixing element fixable, in use, to the door or to the anchoring structure of the door;
a second fixing element fixable, in use, to the anchoring structure of the door or to the door;
at least one elastic flexible element which performs, due to its configuration, an elastic function when it is subjected to bending;
fixing means by which said at least one elastic flexible element is fixed to said second fixing element; and
engaging means by which said at least one elastic flexible element remains engaged to said first fixing element during the relative motion between said first and said second fixing element, which is caused by said door moving between said closing position and said maximum opening position and between said maximum opening position and said closing position;
in the configuration assumed by the device when the door is at least partially open, said at least one elastic flexible element being subjected to bending and tending to automatically move said door to said closing position.

2. Device according to claim 1, characterized in that it comprises a plurality of elastic flexible elements, each performing, due to its configuration, an elastic function when it is subjected to bending, said elastic flexible elements being adjacent to one another, fixed to said second fixing element by the fixing means, and kept engaged in said first fixing element by the engaging means during the relative motion between said first and said second fixing element, which is caused by said door moving between said closing position and said maximum opening position and between said maximum opening position and said closing position, in the configuration assumed by the device when the door is at least partially open said plurality of elastic flexible elements being subjected to bending and tending to automatically move said door to said closing position.

3. Device according to claim 2, characterized in that an opening is formed in at least one first elastic flexible element of said plurality of elastic flexible elements and in that at least one second elastic flexible element of said plurality of elastic flexible elements comprises a connecting element which is slidingly engaged in said opening.

4. Device according to claim 1, characterized in that each elastic flexible element is a sheet.

5. Device according to claim 1, characterized in that in the configuration assumed by the device when said door is in said closing position, said at least one elastic flexible element is completely placed within said first and said second fixing element in combination.

6. Device according to claim 1, characterized in that in the configuration assumed by the device when said door is in said maximum opening position, a first end portion of said at least one elastic flexible element is placed within said second fixing element, a second end portion of said at least one elastic flexible element, which is opposite said first end portion, is placed within said first fixing element, and an intermediate portion of said at least one elastic flexible element is placed between said first fixing element and said second fixing element, outside the latter ones.

7. Device according to claim 1, characterized in that it comprises a damping system for damping the return movement of said first fixing element towards said second fixing element, or vice versa, when said door moves from said maximum opening position to said closing position.

8. Device according to claim 7, characterized in that said damping system comprises a rack and a gear which is configured to engage with said rack, said damping system being connected with said at least one elastic flexible element and said first fixing element.

9. Door system for a door or a piece of furniture, comprising an anchoring structure and a door which is rotatably constrained to the anchoring structure and movable between a closing position and a maximum opening position, said anchoring structure being either a fixed structure or a further door, the system further comprising a device for closing the door according to claim 1, the first fixing element being fixed to the door or the anchoring structure of the door, preferably to the door, the second fixing element being fixed to the anchoring structure or the door, preferably to the anchoring structure.

10. System according to claim 9, wherein:
the first fixing element is fitted within a thickness of the door or the anchoring structure, preferably of the door;
the second fixing element is fitted within a thickness of the anchoring structure or the door, preferably of the anchoring structure;
the device for closing the door being concealed and invisible when the door is in closing position.
